(19) United States
(12) Patent Application Publication
(10) Pub. No.: US 2019/0258345 A1
(43) Pub. Date: Aug. 22, 2019

(54) Assembling Structure of Flexible Flat Cable of Touch Panel

(71) Applicants: Meng-Guei Lin, Taoyuan (TW); Li-Ye Yang, Taoyuan (TW)

(72) Inventors: Meng-Guei Lin, Taoyuan (TW); Li-Ye Yang, Taoyuan (TW)

(73) Assignee: Young Fast Optoelectronics Co., Ltd., Taoyuan (TW)

(21) Appl. No.: 15/903,000

(22) Filed: Feb. 22, 2018

(51) Int. Cl. G06F 3/047; G06F 3/044

(52) U.S. Cl. CPC G06F 3/047; G06F 2203/04112; G06F 3/044

(57) ABSTRACT

The assembling structure includes a transparent substrate, a transparent touch sensor and a flexible flat cable (FFC). The transparent substrate has a visible area and a shaded area which is around the visible area. The transparent touch sensor has touch sensing units arranged in a matrix and located within the visible area. Each of the touch sensing units is connected to a contact of a connecting port in the shaded area. The FFC is connected to the connecting port. The FFC includes a flexible insulative film and flat copper foil wires parallelly arranged on the flexible insulative film at regular intervals. All contacts of the connecting port are arranged at regular intervals. A distance between adjacent two of the contacts is the same as that of the copper foil wires. Each of the copper foil wires is electrically conducted to one of the contacts with adding an ACF.

### BACKGROUND OF THE INVENTION

### 1. Technical Field

The invention relates to touch panels, particularly to flexible flat cables (FFC) of touch panels for signal transmission.

### 2. Related Art

Touch panels have been widely applied in various electronic devices to become an important element of human-machine interface. A touch panel includes a transparent substrate. A touch sensor is disposed on the substrate. A central portion of the touch sensor is configured to be a touch sensing area. A circuit area is arranged around the touch sensing area. The circuit area is provided with signal wires connected to the touch sensing area. A connecting portion with contacts is disposed in the circuit area to electrically connect the signal wires. The connecting portion can be adhered with a flexible flat cable (FFC) to make electric connection. When assembling, the touch panel is superposed on the front of an LCD or LCM, and the FFC is attached on the back of the LCD or LCM.

However, current electronic devices always trend lighter and thinner. Especially in the design of display, a screen-to-body ratio is required higher and higher. To satisfy this requirement, the circuit area around the touch panel must be reduced. This causes that a layout space of the signal wires is seriously lowered and that an area of the connecting portion also becomes smaller. As a result, accuracy and difficulty of the manufacturing process becomes higher and the yield rate becomes lower. Also, such a connecting portion and an FFC may be connected with bad accuracy and adhesion. The more the number of the signal wires is, the more serious such a problem is.

### SUMMARY OF THE INVENTION

An object of the invention is to provide an assembling structure of flexible flat cable of touch panel, which can reduce a width of the bezel portion of a touch panel.

Another object of the invention is to provide an assembling structure of flexible flat cable of touch panel, which can lower manufacturing costs and accuracy and increase reliability of production.

To accomplish the above object, the assembling structure of flexible flat cable of touch panel of the invention includes a transparent substrate, a transparent touch sensor and a flexible flat cable (FFC). The transparent substrate has a visible area and a shaded area which is around the visible area. The transparent touch sensor has touch sensing units arranged in a matrix and located within the visible area. Each of the touch sensing units is connected to a contact of a connecting port in the shaded area. The FFC is connected to the connecting port. The FFC includes a flexible insulative film and flat copper foil wires parallelly arranged on the flexible insulative film at regular intervals. All contacts of the connecting port are arranged at regular intervals. A distance between adjacent two of the contacts is the same as that of the copper foil wires. Each of the copper foil wires is electrically conducted to one of the contacts with adding an ACF.

In the invention, the FFC is composed of two flexible films and copper foil wires therebetween.

The invention further includes a bridging port located in the shaded area. The bridging port is provided with bridging points. Each bridging point is electrically connected to one of the touch sensing units, the bridging port is covered by an insulative film adhered on the substrate, the insulative film is provided with through holes corresponding to the bridging points, the insulative film is provided with bridging wires between two adjacent through holes, thereby all of the bridging points on an axis line are electrically connected to each other and then connected to the contact of the connecting port.

In the invention, the touch sensor is a projected capacitive touch sensor, the touch sensor are disposed on an upper surface of the visible area of the substrate, the touch sensor is composed of sensing columns, each of the sensing columns includes a sensing electrode and a plurality of driving electrodes, the sensing electrode and driving electrodes are arranged in an interlaced manner, each driving electrode is electrically connected to one of the bridging points in the bridging port, and each sensing electrode is electrically connected to one of the contacts in the connecting port.

### BRIEF DESCRIPTION OF THE DRAWINGS

FIG. 1 is an exploded view of the invention;

FIG. 2 is a front view of the invention;

FIG. 3 is an enlarged view of circle A in FIG. 1;

FIG. 4 is a schematic view of layout of the sensing electrode in circle A;

FIG. 5 is a schematic view of layout of the driving electrode in circle A;

FIG. 6 is a schematic view of the bridging port of the invention; and

FIG. 7 is an enlarged view of circle B in FIG. 6.

### DETAILED DESCRIPTION OF THE INVENTION

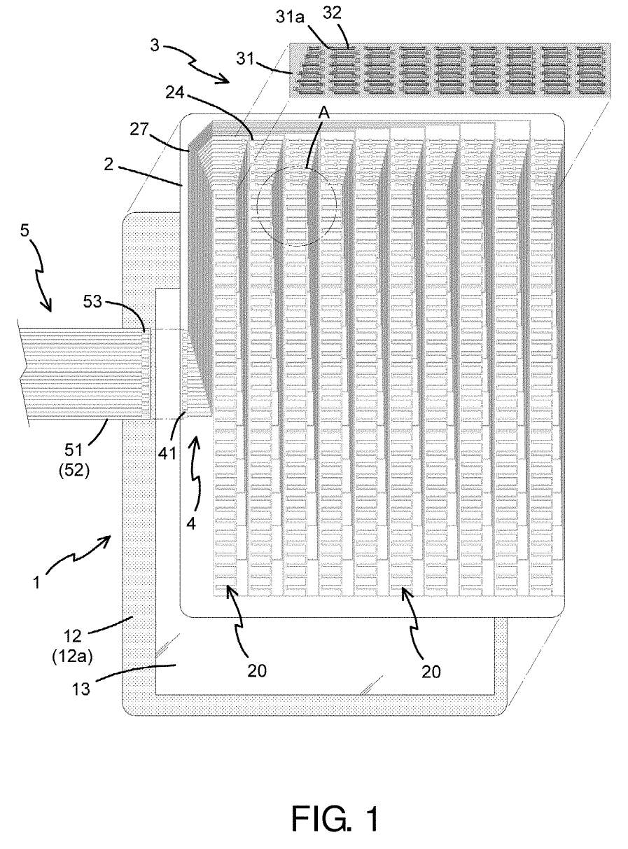

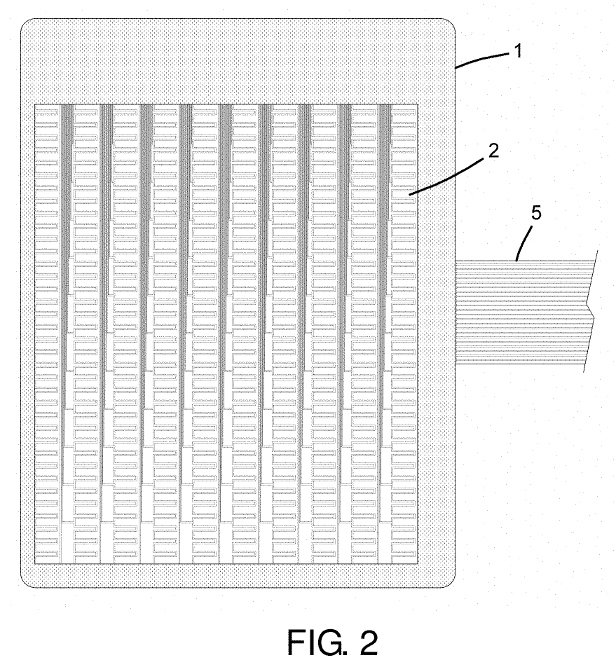

Please refer to FIGS. 1 and 2. The invention includes a transparent substrate 1, a transparent touch sensor 2, a bridging port 3, a connecting port 4 and a flexible flat cable (FFC) 5. The substrate 1 is a thin plate with high transparency and great mechanical strength and is made of, but limited to, glass, poly(methyl methacrylate) (PMMA), polycarbonate (PC), polyester (PE) or cyclic olefin copolymer (COC). A periphery of the bottom of the substrate 1 is a colored bezel 12 formed by an opaque insulative film which may be made of ink or photoresist. Thickness of the film is about 15 μm. As a result, a shaded area 12a is formed by the film and a visible area 13 within the shaded area 13 is also formed.

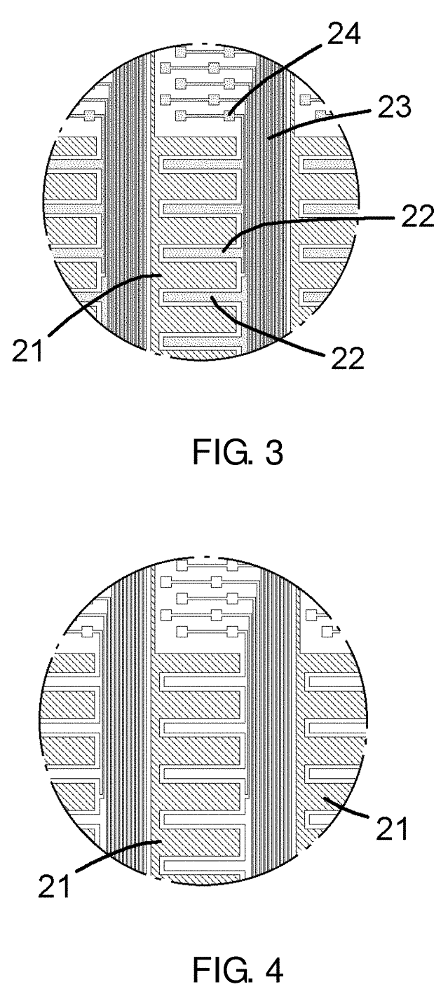

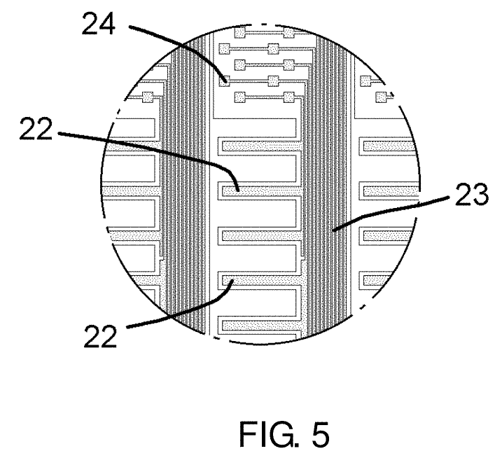

As shown in FIGS. 1 and 3-5. The transparent touch sensor 2 is a projected capacitive touch sensor composed of sensing units 20 arranged in a matrix. The matrix is composed of sensing columns. The sensing units 20 are disposed on an upper surface of the visible area 13. Each of the sensing columns includes a sensing electrode 21 and a plurality of driving electrodes 22. The sensing electrode 21 and driving electrodes 22 are arranged in an interlaced manner. Each driving electrode 22 is electrically connected to a bridging point 24 in a bridging port 3 by a signal wire 23. Each sensing electrode 21 is electrically connected to a contact 41 in a connecting port 4 by a signal wire 27. The touch sensor 2 is made of a material with high transparency, such as an indium tin oxide, indium zinc oxide, aluminum zinc oxide or polyethylenedioxythiophene thin film.

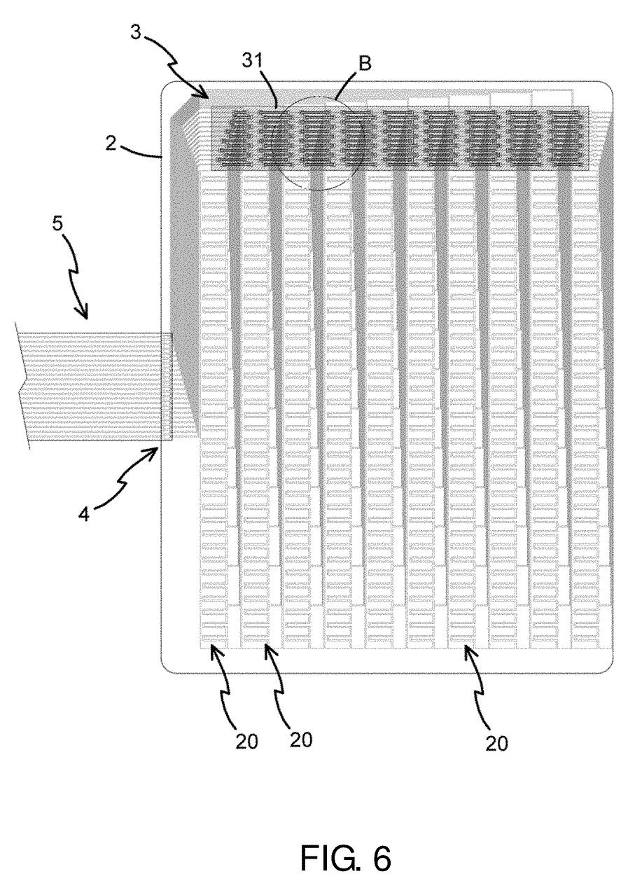

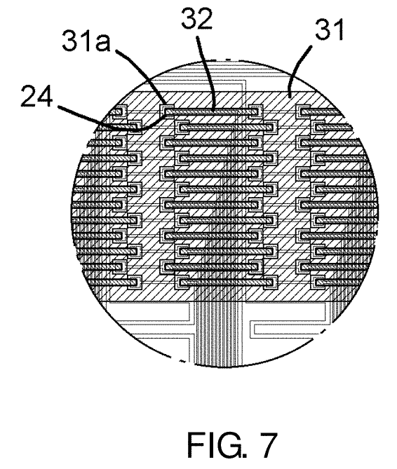

As shown in FIGS. 6 and 7, the bridging port 3 is located in the shaded area 12a. The bridging port 3 is covered by an insulative film 31 adhered on the substrate 1. The insulative film 31 is provided with through holes 31a corresponding to the bridging points 24. The insulative film 31 is provided with bridging wires 32 between two adjacent through holes 31a on an X-axis line. Two ends of each of the bridging wires 32 electrically separately connect the bridging points 24 exposed in the through holes 31a. As a result, all of the bridging points 24 on the same X-axis line can be electrically connected to a single one of the signal wires 27 which are arranged within the shaded area 12a to connect to the contact 41 of the connecting port 4. The abovementioned description is just an example for connecting two adjacent though holes 31a on an X-axis line by using the bridging wires 32 and other applications are not limited to. Using the bridging port 3 to connect the contacts 41 can reduce the number of signal wires and width of the shaded area 12a. As a result, the usable area of the contacts can be enlarged, accuracy and stability of the connection with the FFC 5 can be increased, the manufacturing difficulty can be lowered and the yield rate and reliability of the connection can be enhanced. Also, the area occupied by the signal wires can be retrenched.

Please further refer to FIGS. 1, 2 and 6. The connecting port 4 is disposed in the shaded area 12a on a side of the substrate 1. And the connecting port 4 and the bridging port 3 are located on different sides of the substrate 1. The FFC 5 is composed of two flexible films 51, 52 and copper foil wires 53 therebetween. A front end of the FFC 5 may be connected to the connecting port 4 so as to make the copper foil wires 53 electrically the contacts 41 in the connecting port 4. An anisotropic conductive film (ACF) is used between them to make electrical connection. As a result, the touch signals from the touch sensor 2 can be transmitted to a control unit (not shown) through the FFC 5.

The invention may also be applied to resistive touch panels or electromagnetic touch panels. Additionally, in the above embodiment, the signal wires 27 of the touch sensor 2 are aggregated into the connecting port 4. However, in actual applications, the connecting port 4 may be more than one in number and they can be individually connected with respective FFCs.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An assembling structure of touch panel, comprising:
a transparent substrate, having a visible area and a shaded area which is around the visible area and formed by a colored bezel;
a transparent touch sensor, having touch sensing units arranged in a matrix and located within the visible area, each of the touch sensing units being connected to a contact of a connecting port;
a flexible flat cable (FFC), connected to the connecting port; and
a bridging port, located in the shaded area, covered by an insulative film adhered on the substrate, provided with bridging points in lines in the shaded area, each bridging point being electrically connected to one of the touch sensing units, the insulative film being provided with through holes corresponding to the bridging points to make each of the bridging points separately exposed in one of the through holes, the insulative film being provided with bridging wires between adjacent two of the through holes, two ends of each of the bridging wires electrically separately connecting two of the bridging points in a line, the bridging wires being arranged in lines or in parallel, all of the bridging points on an axis line being electrically connected to each other and then connected to the contact of the connecting port;
wherein the FFC comprises a flexible insulative film and flat copper foil wires parallelly arranged on the flexible insulative film at regular intervals, the connecting port is located in the shaded area, all contacts of the connecting port are arranged at regular intervals, a distance between adjacent two of the contacts is the same as that of the copper foil wires, each of the copper foil wires is electrically conducted to one of the contacts with adding an anisotropic conductive film (ACF) to make an electric connection.

2. The assembling structure of touch panel of claim 1, wherein the FFC is composed of two flexible films and copper foil wires therebetween.

3. (canceled)

4. The assembling structure of touch panel of claim 1, wherein the touch sensor is a projected capacitive touch sensor.

5. The assembling structure of touch panel of claim 4, wherein the touch sensor are disposed on an upper surface of the visible area of the substrate.

6. The assembling structure of touch panel of claim 5, wherein the touch sensor is composed of sensing columns, each of the sensing columns includes a sensing electrode and a plurality of driving electrodes, the sensing electrode and driving electrodes are arranged in an interlaced manner, each driving electrode is electrically connected to one of the bridging points in the bridging port, and each sensing electrode is electrically connected to one of the contacts in the connecting port.
